(19) United States
(12) Patent Application Publication
(10) Pub. No.: US 2013/0154193 A1
(43) Pub. Date: Jun. 20, 2013

(54) Seal for a Journal Assembly for a Pulverizer and Method of Using the Same

(71) Applicants: Randal Michael Racine, Westfield, MA (US); Christopher D. Curl, Branford, CT (US); Theron J. Bliss, Enfield, CT (US)

(72) Inventors: Randal Michael Racine, Westfield, MA (US); Christopher D. Curl, Branford, CT (US); Theron J. Bliss, Enfield, CT (US)

(73) Assignee: ALSTOM TECHNOLOGY LTD, Baden (CH)

(21) Appl. No.: 13/331,290

(22) Filed: Dec. 20, 2011

(51) Int. Cl. F16J 15/52; F16J 15/02

(52) U.S. Cl. 277/315; 277/628; 277/636; 277/312

(57) ABSTRACT

A system for sealing a port of a pulverizer. A pulverizer has journal assembly and a port for receiving the journal assembly. At least a portion of the journal assembly extends through the port. The system further includes a seal having a first end and a second end. The seal includes a first opening at or near the first end and a second opening at or near the second end. A bore extends between the first opening and the second opening. One of the first end and the second end is coupled to the pulverizer and the other one of the first end and the second end is coupled to the journal assembly. The seal inhibits fluid communication through the port.

### TECHNICAL FIELD

The field of the disclosure relates to pulverizers and more specifically to a seal for a journal assembly for a pulverizer and a method of using the same.

### BACKGROUND

Coal is typically used as a fuel in boilers in power plants. Before the coal is introduced into a combustion area in a boiler and combusted, it typically undergoes a pulverization process to reduce the size of the coal from relatively coarse chunks to a fine powder. This is typically done to increase the reactivity of the coal by increasing the effective surface area, to reduce surface moisture on the coal, and to make transportation of the coal into the combustion area easier. The coal is transformed into the above-described fine powder by a pulverizer. There are different types of pulverizers, for example, there are ball-type pulverizers, roll-bowl or ball race pulverizers, impact or hammer pulverizer mills, and attrition type pulverizers. After the coal is pulverized it is typically conveyed using pressurized air from the pulverizer through a port and further conveyed through one or more conduits.

### SUMMARY

According to aspects illustrated herein, there is provided a system for sealing a port of a pulverizer. A pulverizer generally has a journal assembly and a port for receiving the journal assembly. At least a portion of the journal assembly extends through the port. The system further includes a seal having a first end and a second end. The seal includes a first opening at or near the first end and a second opening at or near the second end. A bore extends between the first opening and the second opening. One of the first end and the second end is coupled to the pulverizer and the other one of the first end and the second end is coupled to the journal assembly. The seal inhibits fluid communication through the port.

According to other aspects illustrated herein, there is provided a method for sealing a portion of a pulverizer. The method includes the steps of providing a pulverizer having a port. A journal assembly is provided. A least a portion of the journal assembly is extended through the port. A seal is provided having a first end and a second end, a first opening and a second opening, and a bore extending between the first opening and the second opening. One of the first end and the second end of the seal is coupled to the pulverizer. The other of the first end and the second end of the seal is coupled to the journal assembly. The seal inhibits fluid communication through the port.

The above described and other features are exemplified by the following figures and detailed description

### BRIEF DESCRIPTION OF THE DRAWINGS

FIG. 1 is a cross-sectional view of a pulverizer.

FIG. 2 is a perspective view of a seal coupled to a pulverizer.

FIG. 3 is a cross-sectional view of a portion of a pulverizer and a seal.

FIG. 4 is a perspective view of a seal.

FIG. 5 is a cross-sectional view of the seal shown in FIG. 3.

### DETAILED DESCRIPTION

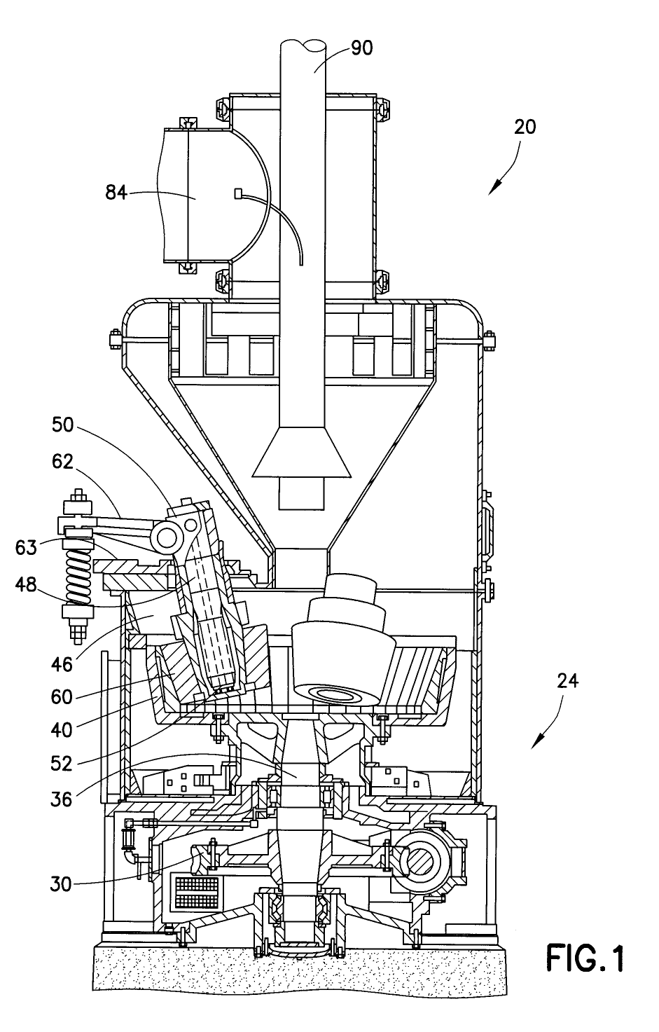

As shown in FIG. 1, a pulverizer is generally designated by the reference number 20. The pulverizer 20 is exemplary of a roll-bowl type pulverizer. While the description herein will be made with respect to such a pulverizer, the disclosure is not to be limited in this regard as it is applicable to other types of pulverizers, such as, but not limited to, impact-type pulverizers, hammer-type pulverizers, and attrition-type pulverizers. In the illustrated embodiment, a coal pulverizer 20 is shown. However, the disclosure is not limited in this regard as it may be employed with pulverizers for different types of material.

The pulverizer 20 includes a housing 24 that supports the pulverizer 20. In the illustrated embodiment, a drive assembly 30 is positioned in the housing 24 and includes a motor (not shown in FIG. 1) that engages a shaft 36. A grinding bowl 40 is coupled to the shaft 36. Three journal assemblies 46 (only one complete shown in FIG. 1) are spaced equidistantly, approximately 120° apart, and positioned in close proximity to the rotating grinding bowl 40. In reference to FIGS. 1-3, each journal assembly 46 includes a shaft 48 that extends between a proximal end 50 and a distal end 52. A grinding roll 60 is rotatably coupled proximate to the distal end 52 of the shaft 48. A suspension assembly 62 is coupled proximate to the proximal end 50 of the shaft 48.

At least a portion of the shaft 48 of the journal assembly 46 extends through a port 66 in the pulverizer 20. The distal end 52 of the shaft 48 is inside the pulverizer 20 and the proximal end 50 of the shaft 48 is outside of the pulverizer 20. The grinding roll 60 contacts a portion of the grinding bowl 40. The suspension assembly 62 is coupled to an outside surface 63 of the pulverizer 20. The suspension assembly 62 supports the journal assembly 46 and suspends, at least in part, the shaft 46 and the grinding roll 60 inside the pulverizer 20. During operation of the pulverizer 20, the grinding bowl 40 is rotated. The rotation of the grinding bowl 40 causes the grinding roll 60 to rotate. Coal, or other suitable material, is introduced into the pulverizer 20 and is crushed between the grinding roll 60 and the grinding bowl 40.

Typically, the outside profile of the shaft 48 of the journal assembly 46 is generally circular. The port 66 through which shaft 48 extends is also generally circular and has a diameter greater than an outside diameter of the shaft 48. Typically, a substantial clearance is provided between the outside diameter of the shaft 48 and the diameter of the port 66 to allow relative motion between the journal assembly 46 and the pulverizer 20 during operation.

In the illustrated embodiment, a feed inlet 84 deposits raw material into the center of the grinding bowl 40. The raw material is then uniformly distributed radially by centrifugal force to the grinding zone of the bowl 40 where the material is then crushed by grinding rolls 60. While the material is repeatedly crushed and ground to a finer consistency, conveyance gas, usually air, is forced into the housing 24 and the finer particles are carried upwardly. Particles that are fine enough are conveyed through a port 90 while larger particles are returned for further grinding. Typically, one more conduits deliver the particles to a combustion area. In the above description, the pulverized product is referred to as particles to illustrate the effect of pulverization; however, the resultant product may also be referred to as a pulverized product, processed product, or any other name that indicates it has been pulverized. In the above description, a conveyance gas is described as being forced into the housing to move particles through the system. It should be understood that a pulverizer in accordance with the present invention can operate under a negative pressure, in which air is drawn through the system, or under positive pressure, in which air is pushed into the system.

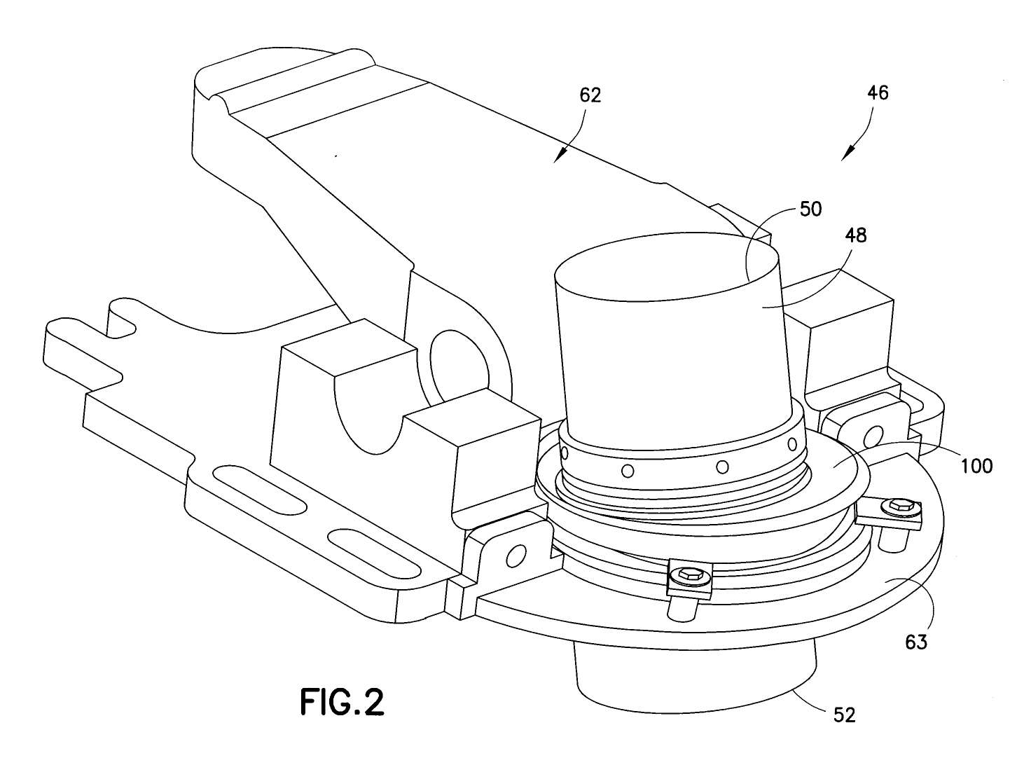

In FIGS. 2-5, a seal 100 is shown. The seal 100 is a bellows type seal. Although a bellows type seal is shown, the present invention is not limited in this regard. For example, a seal may be used without bellows. The seal 100 extends between a first end 110 and a second end 120. In the description, the first end 110 of the seal 100 is typically shown as the bottom of the seal, and the second end 120 of the seal 100 is typically identified as the top of the seal 100. However it should be readily appreciated that the identification of components of the seal with terms such as first and second, and the like, is a drafting convention and is not, in any way, intended to limit the scope of the disclosure.

The seal 100 has a first opening 112 at or adjacent to the first end 110. The seal 100 has a second opening 122 at or adjacent to the second end 120. The seal 100 has a bore 130 that extends between the first opening 112 and the second opening 122. The seal 100 includes a body 140, through which the bore passes, that extends from the first end 110 to the second end 120. The body 140 has at least one fold between the first end 110 and the second end 120 to form a bellows 150. The bellows 150 extends around the body 140 to form a ring. It should be understood that the disclosure is not limited to having a single bellows, and that many different configurations can be used. For example, the seal can be used with a body 140 having a plurality of bellows, or the seal may be used with a body not including any bellows. In the above description, the bellows 150 are described as extending around the circumference of the annular portion of the body. However, the disclosure is not limited in this regard as it may include a bellows that extends, for example, only around a portion of the body 140 of the seal 100.

The first end 110 of the seal 100 is adapted to be coupled to the port 66 of a pulverizer 20. The seal 100 includes a first flange 160 radially extending from a portion of the seal 100 that defines an edge 114 of the first opening 112. The flange 160 extends around the entire seal 100 in a plane defined by the first opening 110. The first flange 160 is used to couple the first end 110 of the seal 100 to an area 63 of the pulverizer 20. In the above description, the seal 100 is described as having a first flange 160 for interfacing the seal 100 with an area 63 of the pulverizer, however, the disclosure is not limited in this regard and many different methods and configurations for coupling may be employed, such as, but not limited to, strapping, buckles, screws, clamps, or the like.

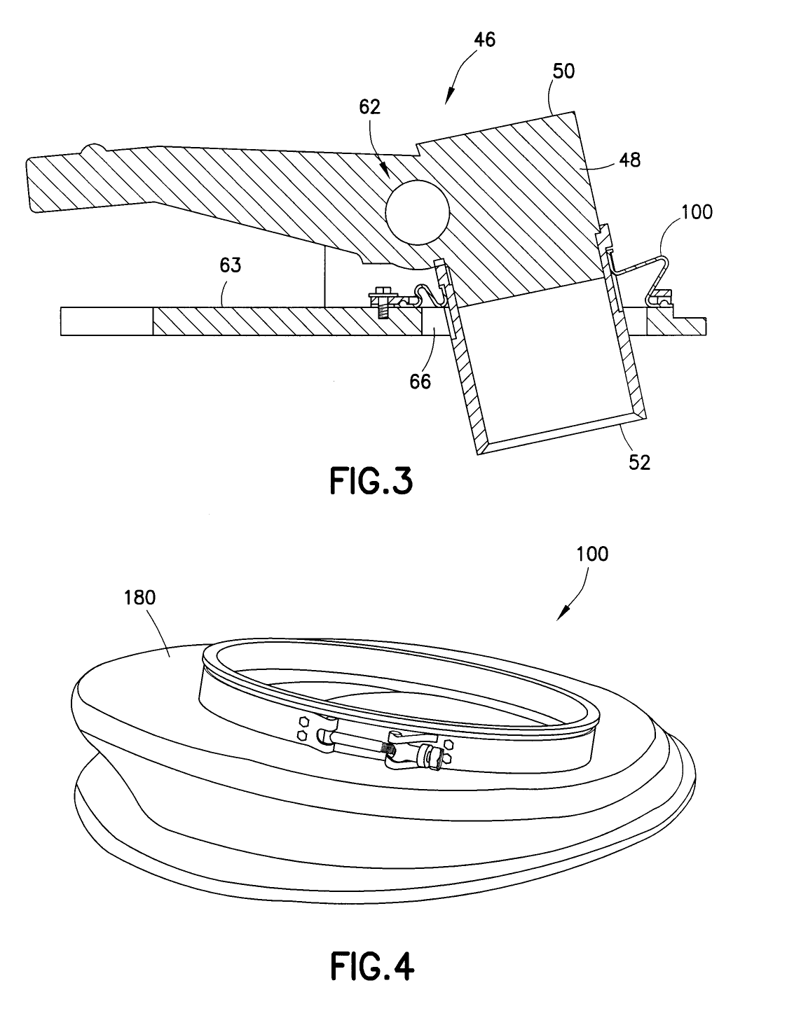

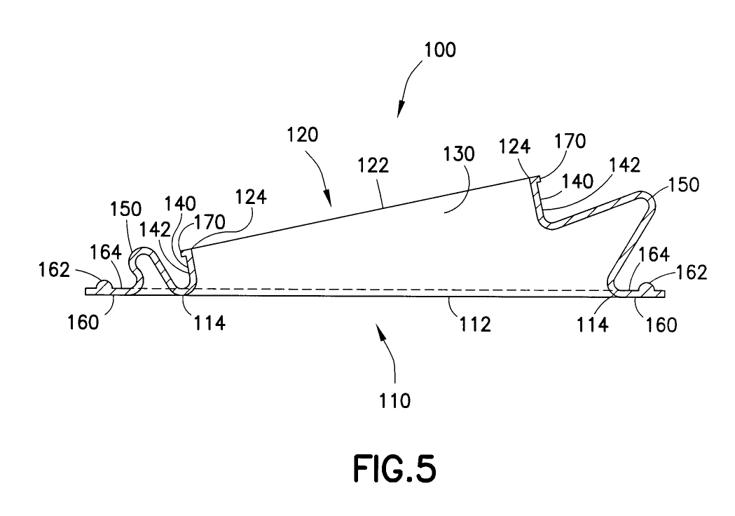

The second end 120 of the seal 100 is adapted to be coupled to the shaft 48. The seal 100 includes a second flange 170 radially extending from a portion 124 of the sealing member 100 that defines an edge of the second opening 122. The second flange 170 extends around the entire seal 100 in a plane defined by the second opening 120. In an area 142 below the second flange 170 on an outside surface of the body 140 of the seal 100, the seal 100 is substantially cylindrical. As discussed above, at least a portion of the shaft 48 of the journal assembly 46 extends through the port 66. Similarly, at least a portion of the shaft 48 extends through the second opening 122 and the first opening 112. The second end 120 of the seal 100 is coupled to an outside surface of the shaft 48. A clamp 180 (shown in FIG. 4 as a hose type clamp) surrounds the outer portion 142 of the seal 100 in the area below the second flange 170. The clamp 180 is tightened to releasably retain the second end 120 of the seal 100 on the outside surface of the shaft 48 (shown in FIGS. 2 and 3). In the above description, the seal 100 is described as having a second flange 170 and is shown being coupled to the shaft 48 by a hose clamp 180. However, the disclosure is not limited in this regard as many different methods of coupling may be employed.

The seal 100 is made from a suitable material, such as, but not limited to rubber. In the embodiment shown, the seal is made from rubber ethylene propylene diene mononomer. This synthetic rubber material allows the seal 100 to stretch while returning to its original shape. This material is also more heat resistant than known materials and, therefore, will not break down. In addition, this material has a greater wear to resistance than known materials and, therefore, increases the overall service life of this part and the components this part protects.

During operation of the pulverizer 20 in which a seal 100 has been implemented a pressure difference is created between an air outside the pulverizer and an area inside the pulverizer due to the conveyance of air used to transport the crushed material. As discussed above, the seal 100 and the coupling of the first end 110 to the pulverizer 20 and the second end 120 to the shaft 48 inhibits the flow of fluid through the port 66. As a result, this design inhibits coal dust from escaping from the pulverizer, and this design inhibits ambient air from being drawn into the system. For example, in a negative pressure system.

As can be appreciated by a person of ordinary skill in the art, a pulverizer, as described above, typically vibrates during operation. Under some conditions these vibrations can be relatively severe and unpredictable. As a result, there can be movement between the shaft and an edge of the port. The seal in accordance with present invention is operable to absorb relative movement between pulverizer and the journal assembly while inhibiting fluid communication through the port. More specifically, the baffles of the seal absorb motion and forces from the pulverizer and allow the seal to stretch. The extra material of the baffles, for example, allows the first end of the seal to move relative to the second end of the seal while maintaining the integrity of the couplings. Additionally, the shape of the seal is configured so that pulverizer and the journal assembly do not exert a substantial stress on the seal when the pulverizer is in a resting position, thereby inhibiting degradation of the seal.

Although the present invention has been disclosed and described with reference to certain embodiments thereof, it should be noted that other variations and modifications may be made, and it is intended that the following claims cover the variations and modifications within the true scope of the invention.

What is claimed is:

1. A system for sealing a port of a pulverizer, comprising:
a pulverizer having a port and a journal assembly, a least a portion of the journal assembly extending through the port;
a seal having a first end and a second end, a first opening adjacent to the first end, a second opening adjacent to the second end, and a bore extending between the first opening and the second opening;
one of the first end and the second end being coupled to the pulverizer and the other one of the first end and the second end being coupled to the journal assembly;
wherein the seal inhibits fluid communication through the port.

2. The system of claim 1, wherein the seal defines one or more bellows between the first and the second end.

3. The system of claim 2, wherein the seal is operable to absorb relative movement between the pulverizer and the journal assembly while inhibiting fluid communication through the port.

4. The system of claim 3, wherein the seal comprises rubber.

5. The system of claim 4, wherein the seal comprises ethylene propylene diene mononomer.

6. The system of claim 1, wherein the first opening and the second opening are substantially circular.

7. The system of claim 6, wherein at least a portion of the journal assembly extends through the first opening and the second opening of the seal.

8. The system of claim 7, further comprising a flange radially extending from a portion of the seal defining the first opening.

9. The system of claim 8, wherein at least a portion of the flange is coupled to an area of the pulverizer proximate to the port.

10. A method for sealing a port on a pulverizer, comprising the steps of:
providing pulverizer having a port;
providing a journal assembly, a least a portion of the journal assembly being extending through the port;
providing a seal having a first end and a second end, a first opening adjacent to the first end, a second opening adjacent to the second end, and a bore extending between the first opening and the second opening;
coupling one of the first end and the second end to the pulverizer;
coupling the other one of the first end and the second end to the journal assembly;
wherein the seal inhibits fluid communication through the port.

11. The method of claim 10, wherein the seal defines one or more bellows between the first and the second end.

12. The method of claim 11, wherein the seal is operable to absorb relative movement between the pulverizer and the journal assembly while inhibiting fluid communication through the port.

13. The method of claim 10, wherein the seal comprises rubber.

14. The method of claim 13, wherein the seal comprises ethylene propylene diene mononomer.

15. The method of claim 10, wherein the first opening and the second opening are substantially circular.

16. The method of claim 15, wherein at least a portion of the journal assembly extends through the first opening and the second opening.

17. The method of claim 16, further comprising the step of:
providing a flange radially extending from a portion of the seal defining the first opening.

18. The method of claim 17, wherein at least a portion of the flange is coupled to an area of the pulverizer proximate to the port.
